(19) United States
(12) Patent Application Publication
(10) Pub. No.: US 2011/0033667 A1
(43) Pub. Date: Feb. 10, 2011

(54) COMPLEX PARTITION GLASS CONSISTING OF AT LEAST TWO ADJACENT GLASS ELEMENTS, AND METHOD FOR PRODUCING SAID COMPLEX PARTITION GLASS

(75) Inventors: Jean-Gerard Leconte, Courbevoie (FR); Yann Tombette, Compiegne (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN GLASS FRANCE, Courbevoie (FR)

(21) Appl. No.: 11/721,733

(22) PCT Filed: Dec. 9, 2005
(86) PCT No.: PCT/FR2005/051065

§ 371 Date: Nov. 24, 2009

(30) Foreign Application Priority Data
Dec. 14, 2004 (FR) 0452983

(51) Int. Cl. B32B 3/02; B32B 37/12; B32B 37/16; B32B 37/14; B32B 17/06

(52) U.S. Cl. 428/157; 156/60; 156/244.11; 156/244.12

(57) ABSTRACT

The invention relates to a complex partition glass (1) consisting of at least two glass elements (10; 20) which are adjacent according to at least one edge section (11; 21) and separated from each other by a gap (2). Said partition glass is characterised in that a first glass element (10) is provided beneath an edge (12) of at least one section of a rigid profiled element (13) which projects past said edge and provides a support for a second glass element (20).

The present invention relates to complex glazing consisting of at least two glazed elements that are contiguous along at least a portion of edge and separated from each other by a space.

It also relates to the fixing of such complex glazing in an opening and in particular a bodywork opening.

In the prior art and in particular from the French patent application N^{o} FR 1 227 870 it is known to produce laterally panoramic glazings in a single piece and in particular laterally panoramic windscreens having a large convexity about a first axis of curvature and a very low convexity about a second axis, substantially perpendicular to the first one; this kind of glazing is of the cylindrical type; these glazings comprise practically no curvature towards the roof of the vehicle.

At present, because of the convexity producing methods used in the glass industry, the industrial feasibility of glazing having a double convexity, in two substantially perpendicular directions, is subject to a special study before initiating manufacturing.

In particular, convexity in the vertical direction becomes difficult after 30 mm when conventional shaping methods are used and when the convexity in the other direction (bowing) is significant.

With pressing methods, it is possible to increase the convexity (beyond 30°) and in particular to make quasi-spherical shapes, but the more pronounced the convexity becomes, the greater is the risk regarding optical quality; it is therefore particularly difficult to implement such methods for manufacturing, at high rates, glazings that have to meet very strict standards, such as for example the manufacture of automobile glazing.

It is also known in the prior art to produce laterally panoramic glazing and in particular laterally panoramic windscreens by coupling a main glazing (windscreen) with secondary glazings (fixed front side glazings) using the thinnest possible lateral bodywork members in order to give panoramic vision through this complex glazing.

However, these lateral members are ugly and interfere with lateral panoramic vision.

It is also known in the prior art to produce longitudinally panoramic glazings and in particular longitudinally panoramic windscreens by coupling a main glazing (windscreen) with a secondary glazing (fixed roof glazing) using a longitudinal or traverse bodywork member. In this context, the French patent application N^{o} FR 2 373 432 is known in the prior art.

However, this longitudinal member is also ugly and interferes with panoramic vision at the top of the windscreen, between the windscreen and the transparent roof. Moreover, this transverse member supporting the two glazings at their junction is situated at the head-level of the front passengers and it absorbs a lot of light because of its great width, so much so that the benefit in terms of brightness for the inside of the passenger compartment is not as great as could be expected for such a large glazed area.

There is also known in the prior art, from the American patent U.S. Pat. No. 5,784,982, a complex glazing consisting of at least two glazed elements of which each glazed element is provided with a rigid profile, these profiles being intended to cooperate with each other.

Similarly, these profiles are ugly and interfere with panoramic vision.

In order to obtain all of the desired light, to give an impression of increased space inside the passenger compartment, to avoid the interference provided by the upright or transverse members, it therefore appears desirable to have a glazing, in particular a windscreen, having turn-backs, and therefore pronounced bends on several sides simultaneously, in particular on at least three sides.

Furthermore, the production of convex glazing raises great difficulties when the desired convexity is large (in particular greater than 30°) and particularly when this convexity is desired on two opposite sides.

In particular, in order to comply with automobile standards regarding the optical quality of the glazing, the lateral panoramic shape and the spherical shape (laterally and longitudinally panoramic) in principle lead to a reduction in the height of the windscreen and therefore prevents the turn-back over the roof; or, on the contrary, the longitudinal panoramic shape with a turn-back over the roof is not compatible with lateral panoramic turn-backs.

At present it is not therefore possible to produce a glazing which is convex to a great degree on three sides and which meets the requirements of automobile standards with regard to the optical quality of the glazing.

The purpose of the invention is to overcome the disadvantages of the prior art by proposing a complex glazing which provides very high general visibility through its main face and its sides and/or its roof.

The complex glazing according to the invention therefore makes it possible to produce a laterally and/or longitudinally panoramic windscreen without respectively lateral and/or longitudinal bodywork members.

The present invention thus relates in its widest sense to complex glazing according to claim 1.

This glazing consists of at least two glazed elements that are contiguous along at least a portion of edge and separated from each other by a space, a first glazed element being provided under one side with at least a portion of rigid profile protruding beyond said edge and forming a support for a second glazed element.

In the context of the present invention, the term “portion of edge” refers to a portion along the length and/or the height of the edge; in fact, it is important that the glazings are contiguous.

In the context of the present invention, the term “glazed element” refers to any mineral (glass in particular) or organic (plastic) monolithic glazing or any glazing consisting of several mineral and/or organic sheets assembled with each other. These glazed elements can be flat or convex including doubly convex about two substantially perpendicular axes. These glazed elements are at least partially transparent and can have heat and/or sound insulating properties and/or thermally or electrically variable transparency functions and/or can be heating and/or can carry decorations, in particular enameled ones, and/or functional or decorative layers.

For an application of the invention in the automobile field, each glazed element corresponds to the standard applicable to it according to its position with respect to the vehicle.

It is important to understand here that inside of a complex glazing according to the invention the glazed elements can be of different natures: the first glazed element can for example be a sheet of monolithic glass, for example convex and heat-tempered, and the second glazed element can for example be laminated glazing consisting of two sheets of glass, for example convex (including doubly convex) assembled with each other by an intermediate sheet made of plastic, for example polyvinyl butyral (PVB).

It is also important to understand that it is not necessary for the first glazed element and the second glazed element to have the same thickness.

A space between the two contiguous glazed elements is necessary to make it possible to compensate for the possible dimensional deviations of the glazed elements and the different orientations of the adjacent edges of the glazed elements.

This space can have a cross-section of triangular or even parallelepipedic shape, depending on the distance between the edges of the contiguous glazed elements.

The external faces of the glazed elements, those which are opposite to the face coupled with the portion of rigid profile, are preferably aligned along the same general curvature, particularly for aesthetic and water-tightness reasons, but this is not essential.

Moreover, in the case where a glazed element is not flat but is convex along the edge provided with the portion of profile, this portion of profile is preferably convex substantially having the same curvature as the side of the glazed element, whether it is a first of a second glazed element.

According to the invention, the transverse junction between the first glazed element on the one hand and the second glazed element on the other hand is produced using a single portion of rigid profile. The rigidity of this profile is such that this profile is not deformable manually.

Also according to the invention, the support of the second glazed element on the rigid profile is such that it allows a detachable fixing of the second glazed element to the profile without risk of damaging the first glazed element or the profile whereas the fixing of the profile to the first glazed element cannot be detached without risk of damage to the first glazed element or to the profile.

The gluing of the glazed elements on the profile makes it possible to ensure the necessary water-tightness of the connections between the different constituents of the complex glazing.

When the fixing of the second glazed element to the profile is detachable, the second glazed element can be replaced if it is damaged without it being necessary to replace the other glazed element or elements; on the contrary, if the fixing of the second glazed element to the profile is not detachable, when the second glazed element is damaged, the entire complex glazing must be replaced.

However the support produced is not necessarily present all along the contiguous sides of the glazed elements; the profile can be partially or completely interrupted one or more times along the contiguous sides of the glazed elements.

Said profile preferably has, in cross-section, the shape of a T or of a Y shape or of an h. This profile can however have faces that are not flat and in particular free faces (which are not in contact with the surfaces of the glazed elements) curved in order to improve the aesthetics of the profile.

The profile can also have, in cross-section, a simple strip shape, that is to say consisting of two flanges. It must be capable of absorbing the flexion forces associated with the fitting of the second glazed element and be capable of absorbing the other mechanical stresses associated with the connection function.

In a variant of the complex glazing according to the invention the branches of the T or of the Y are thus preferably positioned under the sides of the glazed elements and the stem of the T or of the Y is positioned in the space between the glazed elements.

One branch of the T or of the Y can be thicker than the other, this thicker branch then preferably being positioned under the side of said first glazed element.

In another variant of the complex glazing according to the invention, the parallel branches of the h are positioned under the sides of the first glazed element and the stem of the h is positioned under the side of the second glazed element.

In order to increase the light transmission both from the inside and from the outside, said profile is, in one version, at least partially transparent. In this version it can, for example, be made of plastic or of glass. It is possible to make the profile from a material that is less transparent than the glazed elements in order to retain a certain light transmission through it whilst at least partially hiding the edges of the glazed elements.

The plastic material can also be a composite material, based on glass fibers and resin. When the profile is made of glass or of plastic, it can also be transparent, translucent or even opaque.

In another version, said profile is made of metal or of metal alloy and is then glued to the first glazed element. It then has a width and a thickness that are as small as possible.

When the first glazed element is made of plastic, or even of glass, it is possible to mold the profile directly during the molding of the first glazed element.

However, when it is made of glass, it will rather be preferred to glue the profile to the first glazed element, just as when the profile is made of metal or of metal alloy.

In a variant of the invention, the laterally panoramic variant, said first glazed element is at least a partial roof element of a vehicle and said second glazed element is a windscreen, in particular a laterally and/or longitudinally curved windscreen.

In the context of the present invention, the term “laterally or longitudinally curved windscreen” refers to a windscreen with double convexity, such as manufactured with the convexity producing methods used in the prior art.

In this variant, said first glazed element is preferably oriented, in the vicinity of the profile, at an angle that is not flat with the second glazed element and preferably is even oriented at an angle of less than 170°, or even less than 160°.

In another variant of the invention, the longitudinally panoramic version, said first glazed element is at least a partial side glazing element of a vehicle and said second glazed element is a windscreen, in particular a laterally and/or longitudinally curved windscreen.

In this variant, the complex glazing comprises at least a second glazed element consisting of a windscreen, in particular a laterally and/or longitudinally curved windscreen, and two first glazed elements each constituting an at least partial side glazing element of a vehicle, a left one and a right one respectively.

In another variant of the invention, the laterally and longitudinally panoramic version, the complex glazing comprises at least a second glazed element consisting of a windscreen, in particular a laterally and/or longitudinally curved windscreen, two first glazed elements each constituting an at least partial side glazing element of a vehicle and a first glazed element constituting an at least partial roof element of a vehicle.

In the simply laterally panoramic variant or in the laterally and longitudinally panoramic variant said first glazed element is preferably oriented, in the vicinity of the profile, at an angle α, α′ that is not flat with said second glazed element and is preferably oriented at an angle α, α′ close to 120°.

Furthermore, the complex glazing according to the invention preferably comprises a seal positioned between the second glazed element and said first glazed element, this seal at least partially overlapping said profile and able to be at least partially transparent.

The rigid profile according to the invention preferably has an overall width less than 75 mm, or even less than 50 mm, in particular of the order of 40 to 45 mm, or even less, for example of the order of 30 mm. This width can also be of the order to two or three times the thickness of a glazed element or of glazed elements.

The present invention also relates to a first glazed element provided on one edge with a portion of rigid profile protruding beyond an edge of this glazed element for a complex glazing according to the invention.

In a variant this profile preferably exhibits, in cross-section, substantially the shape of a T or of a Y, one branch of the T or of the Y being positioned under the side of the first glazed element and the stem of the T or of the Y being positioned adjacent to the edge of the first glazed element, in such a way that the stem of the T or of the Y thus protrudes beyond the edge of the first glazed element and makes it possible to produce a support surface for receiving a second glazed element.

In one version of the invention, the angle between the branches of the T is not flat and is preferably less than 170°, or even less than 160°.

In another version of the invention, the angle between the branches of the Y is not flat and is preferably close to 120°.

In another variant, the profile exhibits, in cross-section, substantially the shape of an h, the parallel branches of the h being positioned under and over the sides of this first glazed element.

The present invention also relates to a method of producing complex glazing, this glazing being constituted by at least two glazed elements that are contiguous along at least a portion of edge and separated from each other by a space, characterized in that a first glazed element is provided on one edge with a portion of rigid profile protruding beyond said edge and forming a support for a second glazed element and in that the second glazed element is then positioned on said profile, that is to say bearing against this profile.

According to the invention, a first glazed element is positioned before the second glazed element in an assembly jig and/or a first glazed element is positioned before the second glazed element in an opening, in particular in a bodywork opening.

This portion of rigid profile is preferably manufactured previously by extrusion against said first glazed element or by encapsulation against said first glazed element. It can also be previously glued to said first glazed element by a strip of glue.

The second glazed element is preferably glued to said profile by a strip of glue.

Furthermore, a seal is preferably positioned between the second glazed element and said first glazed element, this seal at least partially overlapping said profile.

Advantageously, the present invention thus makes it possible to produce glazed structures which could not be produced in a single piece, in particular glazings and especially automobile glazings which could not be obtained by the present-day methods of producing convexity at least without degrading the optical quality.

Also advantageously, the present invention makes it possible to produce complex glazings which have mechanical strength substantially as good as that of complex glazings of the prior art but whose junctions between the glazed elements are less visible and give rise to lower luminosity losses.

The present invention is of course applicable, but not uniquely, to the production of glazings for vehicles, and in particular for motor vehicles.

The laterally panoramic variant of the invention thus makes it possible to produce a windscreen possibly already convex or doubly convex coupled with glazed side elements which come back towards the front seats of the vehicle at an angle which is preferably acute but which can also be a right angle or even an obtuse angle, without however necessitating the presence of lateral bodywork members.

The longitudinally panoramic version of the invention thus makes it possible to produce a windscreen, possibly already convex or doubly convex, whose upper glazed element extends at least partially, or even completely, over the roof of a vehicle, without however necessitating the presence of a transverse bodywork member at the junction between the at least partial roof element and the glazed windscreen element itself.

The laterally and longitudinally panoramic variant of the invention thus makes it possible to produce a windscreen combining the advantages of the preceding two variants.

The present invention will be better understood on reading the following detailed description of non-limiting examples of embodiment and the appended figures:

FIGS. 1 to 3 each show a vertical longitudinal cross section of the connection between a windscreen and a portion of vehicle roof for a longitudinally panoramic windscreen produced according to a variant of the invention;

FIG. 4 shows a front view of a laterally panoramic windscreen produced according to the invention;

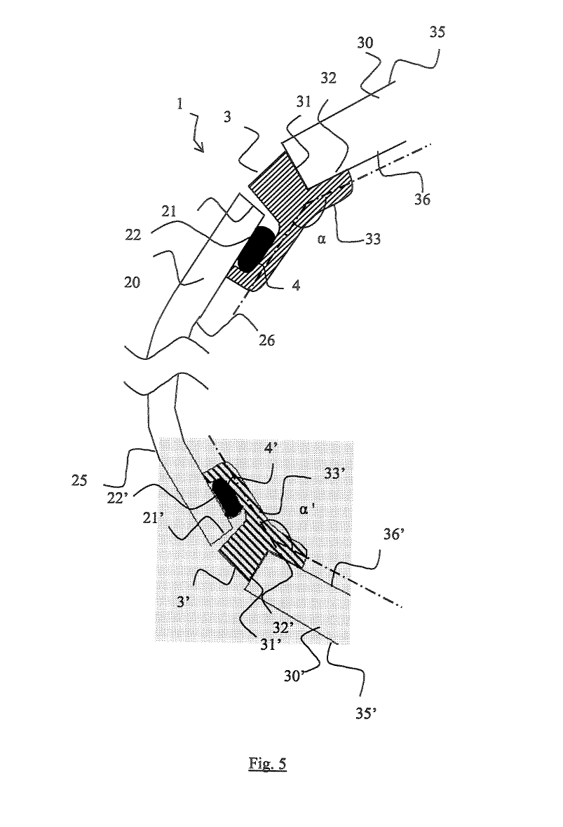

FIG. 5 shows a horizontal cross-section AA′ of FIG. 4; and

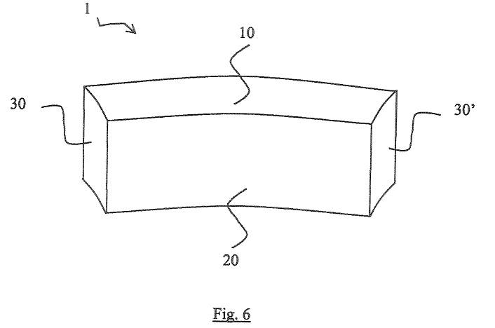

FIG. 6 shows a front view of a laterally and longitudinally panoramic windscreen produced according to the invention.

It is stated that the proportions between the various elements shown are not strictly complied with in these figures in order to make it easier to read them. In particular, in FIG. 5, the space between the glazed elements and the curvature of the second glazed element have been voluntarily increased in order to make it easier to understand the invention.

The present invention is based on the production of complex glazing (1) consisting of two glazed elements (10, 20) such as for example shown in FIGS. 1 to 3, or of three glazed elements (30, 30′, 20) such as for example shown in FIG. 4, or even of four glazed elements (10, 30, 30′, 20) such as for example shown in FIG. 6.

In the variants shown in FIGS. 1 to 3, said first glazed element (10) is an at least partial vehicle roof element and the second glazed element (20) is a windscreen.

In these variants, the first glazed element (10) and the second glazed element (20) are respectively contiguous along at least a portion of edge (11, 21) and are separated from each other by a space (2) of the order of a few millimeters to about ten millimeters, having a parallelepipedic shape in cross-section.

The glazed elements (10, 20) have the same thickness and are here disposed in the complex glazing (1) in such a way that the external face (25) of the second glazed element (20) is continuous with the external face (15) of the first glazed element (10) and that the internal face (26) of the second glazed element (20) is continuous with the internal face (16) of the first glazed element (10).

According to the invention, the first glazed element (10) is provided under a side (12) with at least a portion of rigid profile (13) protruding beyond said edge and forming a support for the second glazed element (20) and more precisely for a side (22) of the second glazed element (20).

As the second glazed element (20) is continuous with the first glazed element (10) and as the curvatures of the glazed elements in the vicinity of the sides (22, 12) are very low, the first glazed element (10) is, in the vicinity of the profile (13), oriented substantially at a flat angle with said second glazed element (20), that is to say that in the vicinity of the sides (22, 12), the mean planes of the glazed elements (20, 10) are merged.

In the variant shown in FIG. 1, the profile (13) is glued to the first glazed element (10) by means of a very thin strip of strong glue (5) solely on the internal face (16) of the first glazed element, but it could also be glued on the edge (11).

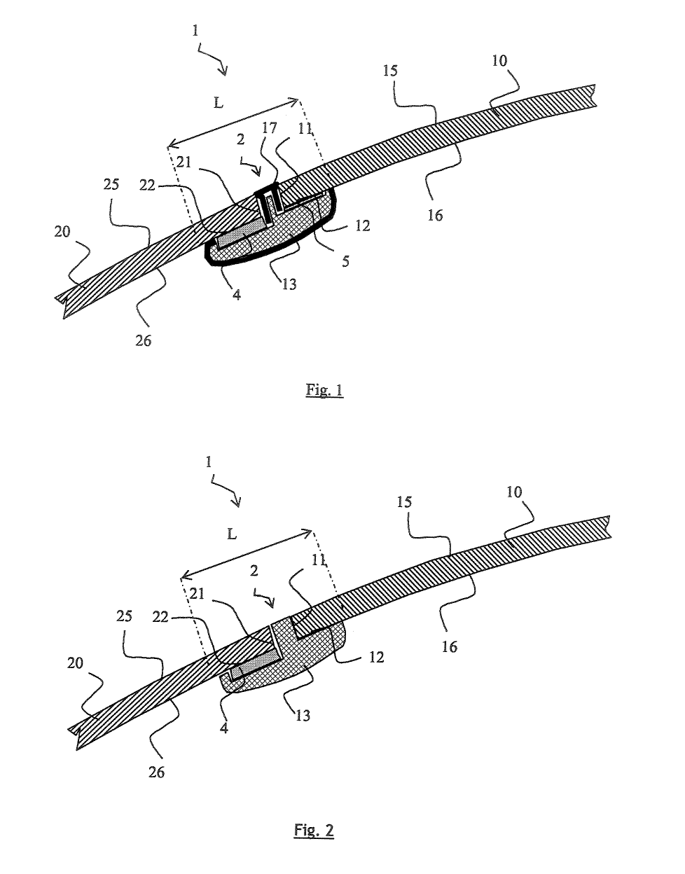

In the variant shown in FIG. 2, the profile (13) is extruded against the internal face (16) and the edge (11) of the first glazed element (10), without using a strip of glue but previously preparing, if necessary, the surface of the glazing, as us usual for the extrusion of a plastic material on glazing.

In these two variants, the profile (13) substantially has the shape of a T in cross section, positioned here in the inverted position and more precisely in the upside down position.

During the manufacture of the complex glazing, before the second glazed element (20) comes to bear on the first glazed element (10), the profile (13) is positioned contiguous with the edge (11) such that the stem of the T is then positioned in the space (2), that is to say between the glazed elements (10, 20) and one branch of the T is positioned under the side (12) of the first glazed element (10) and more precisely in this case under the internal side of the edge (11) and extending against the internal face (16) of the glazed element (10).

When the complex glazing (1) is manufactured, the side (22) of the second glazed element (20) is then positioned on the second branch of the T and the second branch of the T is then situated under the lower side of the edge (21), at a distance of a few millimeters from the internal face (26) of the second glazed element (20).

This distance between the second branch of the T and the inside face (26) allows the positioning of a strip of glue (4) for the gluing of the second glazed element (20) to the profile (13) and thus consequently to the first glazed element (10) during the assembly of the two glazed elements in order to form the complex glazing according to the invention. The free end of this second branch can furthermore be slightly curved back towards the second glazed element in order to facilitate the positioning of the strip of glue (4).

In the variants shown in FIGS. 1 and 2, one branch of the T is thicker than the other: this is the first branch of the T, the one positioned under the side (12) of the first glazed element (10). This thickness makes it possible, on the one hand, to compensate for the distance between the second branch of the T and the internal face (26) allowing the positioning of a strip of glue (4) and, on the other hand, to strengthen the first branch of the T.

In the variant shown in FIG. 1, the profile (13) is made of steel and is covered with a plastic produced for example by molding, coextrusion, etc.

In the variant shown in FIG. 2, the profile (13) is made of plastic which can be used by extrusion, such as for example thermoplastic elastomers (TPE) or thermoplastic olefins (TPO), etc.

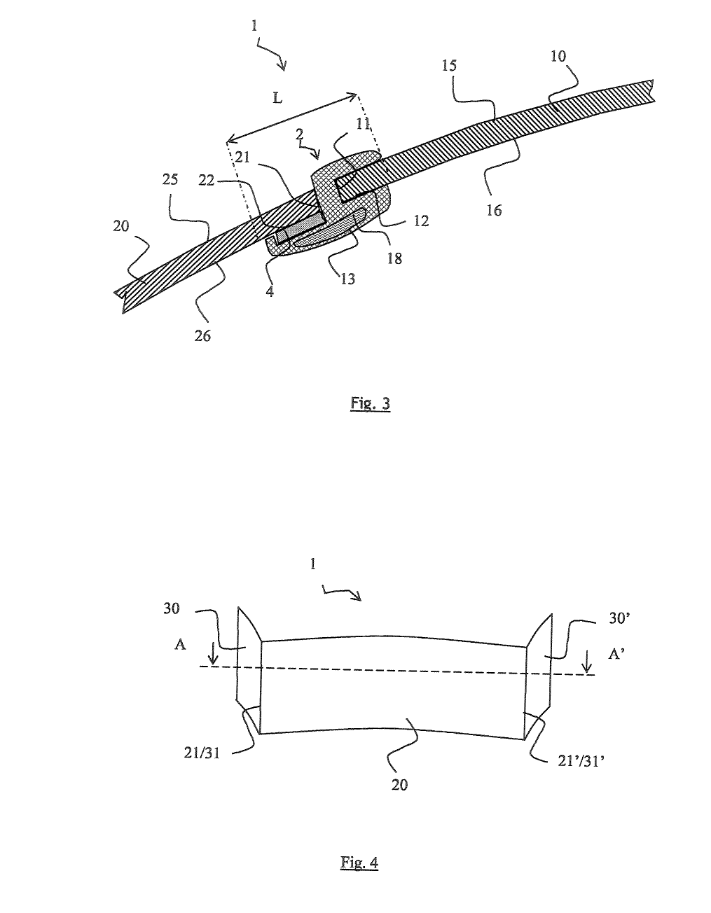

In the variant shown in FIG. 3, the profile (13) is made of plastic which can be used by encapsulation, such as for example a thermoplastic, a PU-RIM (Polyurethane Reaction Injection Molding) or an EPDM, etc.

In this variant, the profile (13) substantially has the shape of an h in cross section, positioned in this case lying along its stem.

The parallel branches of the h are positioned under and over the sides of the first glazed element (10), in such a way as to mount the assembly of the side of the glazing, that is to say in such a way as to be in contact both with the internal side and with the edge and the external side of the first glazed element.

A reinforcing element (18) can be provided inside the encapsulated profile in order to increase rigidity.

The internal side (22) of the second glazed element (20) is thus positioned on the free stem of the h.

In all of these variants, an exceptional pressure on the glazing does not produce plastic deformation of the profile (as opposed to elastic deformation, returning to its initial position after interruption of the force).

The profile (13) has an overall width L of the order of 40 to 45 mm.

In the variant shown in FIG. 1, this profile (13) is covered with a seal (17) manufactured by molding, extrusion or simple added by assembly. This seal (17) fills the residual spaces between the portions of edge (11, 21), or even between the faces of the profile and adjacent portions of edge.

The variant shown in FIG. 1 can be manufactured in different ways:
either by positioning the first glazed element (10) fitted with the profile (13) in a jig for fixing the second glazed element (20) and then positioning the second glazed element (20) in the jig and then fixing the second glazed element (20) to the profile (13) in the jig, in order to obtain a complex glazing (1) which can be positioned as a whole in the bodywork opening in a single positioning operation;
or by positioning and fixing the first glazed element (10) fitted with the profile (13) in the bodywork opening and then positioning the second glazed element (20) in the bodywork opening and then fixing the second glazed element (20) to the profile (13) and to the bodywork, in order to obtain a complex glazing (1) which completely fills the bodywork opening.

In the variant shown in FIG. 4, two glazed elements (30, 30′) are respectively contiguous along a portion of edge (31, 31′) with another glazed element (20), respectively along its portions of edge (21, 21′).

In this variant, said first glazed elements (30, 30′) each constitute a front side glazing element of a vehicle and said second glazed element (20) is a doubly convex windscreen.

The two glazed elements (30, 30′) are of course preferably identical and are situated on either side of the windscreen (20) and each respectively constitutes a front side glazing, right and left respectively with respect to the direction of forward motion of the vehicle. These glazed elements (30, 30′) are disposed symmetrically with respect to a central axis of the windscreen and are intended, of course, to be disposed symmetrically in order to close an opening of a vehicle. The glazed elements (30, 30′) in this case have a height substantially identical to that of the windscreen.

In FIG. 5 it can be seen that the first glazed element (30) and the second glazed element (20) are respectively contiguous along a portion of edge (31, 21) and are separated from each other by a space (3) that is parallelepipedic in cross section, a few millimeters wide, and the first glazed element (30′) and the second glazed element (20) are respectively contiguous along a portion of edge (31′, 21′) and are separated from each other by a space (3′) which is also parallelepipedic in cross section and a few millimeters wide.

The glazed elements (30, 30′) both have the same thickness and are both thicker than the second glazed element (20).

It can also be seen in FIG. 5 that in the complex glazing (1) the external face (25) of the second glazed element (20) is not exactly continuous with the external faces (35, 35′) of the first glazed elements (30, 30′) and that the internal face (26) of the second glazed element (20) is not exactly continuous with the internal faces (36, 36′) of the first glazed elements (30, 30′).

According to the invention, the two first glazed elements (30, 30′) are each provided under a side (32, 32′) with at least a portion of rigid profile (33, 33′) protruding beyond the edge of the glazed element and forming a support for the second glazed element (20), as can be seen in FIG. 3.

The profiles (33, 33′) also make it possible to take up the manufacturing tolerances of the glazed elements.

These profiles (33, 33′) have been produced by encapsulation of a plastic against the edge (31, 31′) and the internal side (32, 32′) of the first glazed elements (30, 30′).

Each of the profiles (33, 33′) substantially have the shape of a Y in cross section. These profiles are identical but are positioned symmetrically with respect to the longitudinal plane of symmetry of the windscreen (20) and of the vehicle once the complex glazing is installed in the bodywork opening.

The stem of the Y is positioned in the space (3, 3′) and a first branch of the Y is positioned under the side (32, 32′) of the first glazed element (30, 30′) and more precisely in this case under the internal side of the edge (31, 31′), extending against the internal face (36, 36′) of the glazed element (30, 30′).

The second branch of the Y is positioned under the side of the second glazed element (20) and more precisely respectively under the internal side of the edges (21, 21′) of the glazed element (20).

In this variant, the cooperation between the glazed elements is identical to that described previously, except that the free end of the second branches of the Y is strongly curved back towards the second glazed element in order to constitute a stop for the support of the second glazed element.

In particular, the second glazed element (20) is respectively glued to the profiles (30, 30′) using a strip of glue (4, 4′).

In the vicinity of each profile (33, 33′), the first glazed element (30, 30′) is oriented at an angle α, α′ that is not flat with said second glazed element (20), the angle α, α′ being close to 120° in this case.

The variant shown in FIGS. 4 and 5 can be manufactured in various ways:
either by positioning the first glazed elements (30, 30′) respectively fitted with profiles (33, 33′) in a jig for fixing the second glazed element (20) and then positioning the second glazed element (20) in the jig and then fixing the second glazed element (20) to the profiles (33, 33′) in the jig, in order to obtain a complex glazing (1) which can be positioned as a whole in the bodywork opening in a single positioning operation;
or by positioning and fixing the first glazed elements (30, 30′) respectively fitted with profiles (33, 33′) in the bodywork opening and then positioning the second glazed element (20) in the bodywork opening and then fixing the second glazed element (20) to the profiles (33, 33′) and to the bodywork, in order to obtain a complex glazing (1) which entirely fills the bodywork opening.

The variant shown in FIG. 6 corresponds to an embodiment combining the variants shown in FIGS. 1 and 4 respectively.

In this FIG. 6, the two front side glazed elements (30, 30′) are contiguous both with the windscreen (20) and the at least partial glazed roof element (10). The glazings (10, 20) are separated form each other by a space (2) as shown in FIG. 1. The glazed elements (30, 20) are separated from each other by a space (3) and the glazed elements (30′, 20) are separated from each other by a space (3′) as shown in FIG. 3.

In this variant, the connections between the front side glazed elements (30, 30′) and the at least partial glazed roof element (10) are also connections according to the invention; this is not however strictly essential and it is possible to provide a traditional bodywork member between the front side glazed elements (30, 30′) and the at least partial glazed roof element (10).

The variant shown in FIG. 6 is manufactured also by combining the manufacturing methods of the preceding variants. As for these preceding variants, it is possible to choose between the complete production of the complex glazing in a jig and then the positioning of this glazing in the opening or the fixing of the first glazed elements in the opening and then the fixing of the second glazed element in the opening.

It is also possible to produce a mixed fixing, that is to say to fix one or more first glazed elements to the second glazed element in a jig and moreover to fix one or more first glazed elements in the opening before fixing the second glazed element in the opening.

The present invention is described above by way of example. It is understood that those skilled in the art are able to produce different variants of the invention without by so doing departing from the scope of the invention such as defined by the claims.

1-28. (canceled)

29. A complex glazing comprising:
at least first and second glazed elements contiguous along at least a portion of an edge and spaced from each other by a space;
wherein the first glazed element is provided under a side with at least a portion of rigid profile protruding beyond the edge and forming a support for the second glazed element.

30. The complex glazing as claimed in claim 24, wherein the rigid profile substantially has a shape of a T or of a Y or of an h in cross section.

31. The complex glazing as claimed in claim 30, wherein the branches of the T or of the Y are positioned under the sides of the glazed elements and the stem of the T or of the Y is positioned in the space.

32. The complex glazing as claimed in claim 30, wherein one branch of the T or of the Y is thicker than the other, the thicker branch being positioned under the side of the first glazed element.

33. The complex glazing as claimed in claim 30, wherein the parallel branches of the h are positioned under and over the sides of the first glazed element and the stem of the h is positioned under the side of the second glazed element.

34. The complex glazing as claimed in claim 29, wherein the rigid profile is at least partially transparent.

35. The complex glazing as claimed in claim 29, wherein the rigid profile is made of plastic or of glass.

36. The complex glazing as claimed in claim 29, wherein the rigid profile is made of metal or of metal alloy.

37. The complex glazing as claimed in claim 29, wherein the first glazed element is an at least partial roof element and the second glazed element is a windscreen, or a laterally and/or longitudinally curved windscreen.

38. The complex glazing as claimed in claim 37, wherein the first glazed element is oriented, in a vicinity of the rigid profile, at an angle that is not flat with the second glazed element or is oriented at an angle of less than 170°, or less than 160°.

39. The complex glazing as claimed in claim 29, wherein the first glazed element is an at least partial side glazing of a vehicle and the second glazed element is a windscreen, or a laterally and/or longitudinally curved windscreen.

40. The complex glazing as claimed in claim 29, comprising at least a second glazed element of a windscreen, or a laterally and/or longitudinally curved windscreen, and two first glazed elements each constituting an at least partial side glazing of a vehicle.

41. The complex glazing as claimed in claim 40, comprising at least a second glazed element of a windscreen, or a laterally and/or longitudinally curved windscreen, two first glazed elements each constituting an at least partial side glazing of a vehicle, and the first glazed element constituting an at least partial roof element of a vehicle.

42. The complex glazing as claimed in claim 39, wherein the first glazed element is oriented in a vicinity of the rigid profile at an angle that is not flat with the second glazed element or is oriented at an angle close to 120°.

43. The complex glazing as claimed in claim 29, further comprising a seal positioned between the second glazed element and the first glazed element, the seal at least partially overlapping the rigid profile.

44. The complex glazing as claimed in claim 29, wherein the rigid profile has an overall width L less than 75 mm, or less than 50 mm, or of the order to 40 to 45 mm, or of the order of 30 mm.

45. A first glazed element provided in one side with at least a portion of rigid profile protruding beyond an edge for a complex glazing as claimed in claim 29.

46. The first glazed element as claimed in claim 45, wherein the rigid profile substantially has a shape of a T or of a Y in cross section, one branch of the T or of the Y being positioned under the side of the first glazed element and the stem of the T or of the Y being positioned adjacent to the edge of the first glazed element.

47. The first glazed element as claimed in claim 46, wherein the angle between the branches of the T is not flat and is less than 170°, or less than 160°.

48. The first glazed element as claimed in claim 45, wherein the angle between the branches of the Y is not flat or is close to 120°.

49. The first glazed element as claimed in claim 45, wherein the rigid profile substantially has a shape of an h in cross section, the parallel branches of the h being positioned under and over the sides of the first glazed element.

50. A method of producing a complex glazing, of two glazed elements contiguous along at least a portion of an edge and separated from each other by a space, comprising:
providing a first glazed element on one side with a portion of rigid profile protruding beyond the edge and forming a support for a second glazed element; and
positioning the second glazed element on the rigid profile.

51. The method as claimed in claim 50, wherein the first glazed element is positioned before the second glazed element in an assembly jig.

52. The method as claimed in claim 50, wherein the first glazed element is positioned before the second glazed element in an opening, or in a bodywork opening.

53. The method as claimed in claim 50, wherein the second glazed element is glued to the rigid profile by a strip of glue.

54. The method as claimed in claim 50, wherein the portion of rigid profile is manufactured previously by extrusion against the first glazed element.

55. The method as claimed in claim 50, wherein the portion of the rigid profile is manufactured previously by encapsulation against the first glazed element.

56. The method as claimed in claim 50, wherein the portion of the rigid profile is manufactured previously and glued previously to the first glazed element by a strip of glue.
